(19) United States
(12) Patent Application Publication
(10) Pub. No.: US 2010/0071829 A1
(43) Pub. Date: Mar. 25, 2010

(54) Accelerated Curing Adhesive For Wood Composites

(76) Inventors: Jay Tanzer, Franklin, TN (US); Jianwen Ni, Franklin, TN (US)

Correspondence Address: WADDEY & PATTERSON, P.C., 1600 DIVISION STREET, SUITE 500, NASHVILLE, TN, 37203, US

(21) Appl. No.: 12/237,801

(22) Filed: Sep. 25, 2008

(51) Int. Cl. B27N 3/02

(52) U.S. Cl. 156/62.2

(57) ABSTRACT

An adhesive system for, inter alia, the manufacturing of wood composites, which includes a MDI adhesive and a formaldehyde-containing resin accelerator.

### BACKGROUND OF THE INVENTION

1. Technical Field

The present invention relates to an adhesive that can be used in the manufacturing of wood-based composites such as oriented strand board, particle board, medium density fiberboard, and composite structural lumber. More particularly, the present invention provides a faster curing adhesive for use with the lower temperature pressing of wood-based composites.

2. Background Art

Wood composites have attracted considerable attention for use as alternatives to natural wood products as wood composites typically exhibit physical properties similar to natural wood lumber. Generally, wood-based composites include particle board, oriented strand board (OSB), wafer board, as well as medium density fiberboard (MDF), with the wood-based composites typically formed from a wood material combined with a thermosetting or heat carrying resin or adhesive to bind the wood substrate together. Depending on the type of wood composite and expected use for the wood composite, different resins are selected based upon strength and bonding properties with each adhesive having specific processing requirements including curing temperature and press time. In order to provide an improved wood composite or increasing the efficiency of producing a composite wood product, a variety of different adhesive systems have been developed.

For example, in Sleeter et al., U.S. Pat. No. 5,942,058, an adhesive system including a fast-setting resin such as polymeric isocyanates and a co-adhesive such as a drying oil is mixed with fibers for binding composite panels including OSB, and particle board plywood, as well as for other types of wood composites. According to Sleeter et al., the drying oil comprises an internal release agent that allegedly prevents the composite panel from sticking to the press utilized in forming the wood composite.

In Berube et al. (U.S. Pat. No. 6,569,801), an adhesive made from a liquid catalyst cross-linked with an amino resin is disclosed which is comprised of a cross-linkable polyvinyl acetate, acid and an amino salt. The catalyst is assertedly a liquid and provides both bond strength and water resistance to the adhesive substance typically being comprised of a copolymer, an acid, and an ammonium salt with a suggested storage life of at least three months.

In U.S. Pat. No. 6,297,313 issued to Hsu, an adhesive system is described including an aldehyde resin and polymeric isocyanate where the adhesive system preferably comprises a sprayable emulsion. More specifically, the combined aldehyde resin and polymeric isocyanate composition is generally described as having an average viscosity of not more than about 500 cps so that the resin is sprayable for use in creating wood composites. Generally, the sprayable adhesive of Hsu contains a mixture of about a 1:1 ratio of aldehyde resin to isocyanate.

Matuana et al., U.S. Pat. No. 6,702,969 discloses a method of making a wood-based composite board with a higher thermal conductivity than other wood-based composites, with the composites of the Matuana et al. patent described as including fillers such as synthetic graphite, metal, carbon, and other similar compounds; thermoset resins are utilized, typically utilizing phenol formaldehyde resin as well as urethane resins.

Gres describes an adhesive system in U.S. Pat. No. 7,064,175. the Gres system consists of powdered tannins and one or both of aldehyde polymers and polymeric isocyanate. Tannin is derived from renewable resources such as trees and plants. It was found that tannins may be used in dry form and provide adhesion without any externally added formaldehyde. It is further asserted by Gres that the disclosed adhesive system achieves better performance than the prior art aldehyde-containing adhesive formulations.

In U.S. Pat. No. 6,886,618 issued to Foucht et al., a system for the catalyzation of thermoset resin adhesives is disclosed that supposedly provides feedback to adjust the curing by the controlled addition of a catalyst to the resin used to bond the wood substrate to form a wood composite. Generally, the system involves multiple feedback loops and specific resin and catalyst flow rates to vary, on a continuous basis, the proportion of the catalyst added during the process for making a wood composite.

Chen et al., U.S. Pat. No. 7,071,248 describes adhesive compositions that include polyisocyanate resins and adhesive additives for use in the manufacture of composite wood products. Generally, the adhesive additives comprise castor oil and one or more triglycerides with the additions allegedly improving cross-link density and also reducing the viscosity of the adhesive composition.

With the extensive use of wood composites, there exists a need to provide an adhesive compound which allows manufacturers to press wood-based composite panels at an improved line speed. The prior art adhesives disclose phenol formaldehyde resins as well as isocyanates, though both types of adhesives have known problems. Phenol formaldehyde resins are not able to consistently bond wood panels of high moisture content and require a significant amount of adhesive for use. Isocyanates are also known within the industry. Both phenol formaldehyde and isocyanates typically require high press temperatures in order to maintain acceptable productivity without the addition of a catalyst. Furthermore, high temperature pressing results in increased emission of volatile organic compounds (VOCs) and hazardous air pollutants (HAPs).

What is desired, therefore, is an accelerated isocyanate adhesive which provides a faster cure rate than prior art wood adhesives where the faster adhesive cure rate of the adhesive makes the adhesive ideally suited for use with a lower press temperature process, which results in lower emissions of VOCs and HAPs.

### SUMMARY OF THE INVENTION

The present invention provides an MDI adhesive system which is uniquely capable of improving the process for creating wood-based composite materials by curing faster and thereby reducing emissions. The inventive adhesive exhibits a faster cure rate than conventional wood adhesives utilized in forming wood-based composite materials and specifically provides a faster cure rate at lower press temperatures not heretofore seen. In addition, the use of the novel adhesive may provide for lower press temperatures while not requiring the installation of costly air pollutant abatement controls as emissions may be decreased from the use of the adhesive.

Generally, wood-based composites created with the use of the novel adhesive of the present invention utilize wood particles which may be generally described as lignocellulosic materials including hard wood, soft wood, and combination of both as well as other lignocellulosic substrates. Lignocellulosic materials may be described as the biomass of plants, generally including cellulose, hemicellulose, and lignin. Most often, wood-base composites such as fiberboard and particle board are produced from lignocellulosic particles bonded within an adhesive and may also be formed from lower grade wood materials as well as lignocellulosic waste created in other wood product production.

An additional class of wood composite materials includes oriented strand board (OSB) which comprises layers of thin lignocellulosic strands, generally wood particles having a length several times greater than their width. In forming OSB with the adhesive of the present invention, the strands are generally positioned relative to each other with their length having a substantial parallel orientation generally parallel to the edge of one of the layers. Further description of the details of the specific orientation of the lignocellulosic strands including desirable layering and positioning are described in U.S. Pat. No. 3,164,511; U.S. Pat. No. 4,364,984; U.S. Pat. No. 5,435,976; U.S. Pat. No. 5,470,631; U.S. Pat. No. 5,525,396; and U.S. Pat. No. 5,718,786, the disclosures of each of which are incorporated herein by reference in their entirety.

The novel adhesive used in forming the wood-based composite material may be described as MDI adhesive with a formaldehyde-containing resin accelerator. Generally, the MDI adhesive comprises an organic isocyanate polymer compound having at least about two active isocyanate groups per molecule.

The formaldehyde-containing resin accelerator may include a variety of known formaldehyde-containing resins. Possible formaldehyde-containing resins include phenol formaldehyde, urea-formaldehyde, melamine formaldehyde, melamine urea-formaldehyde, melamine-urea-phenol-formaldehyde, combinations thereof as well as other formaldehyde-containing resins.

The formaldehyde-containing resin accelerator is generally added to the MDI adhesive at an amount less than about 40% by weight of the total adhesive mixture. Preferably, the formaldehyde-containing resin accelerator is added in an amount of from about 1% to about 5% to the MDI adhesive. Advantageously, such amounts of formaldehyde-containing resin may accelerate MDI reaction resulting in a faster cure rate at a significantly lower temperature than the prior art. Furthermore, the formaldehyde-containing resin is dispersible within the MDI adhesive thus increasing the catalytic activity of the formaldehyde-containing resin on the MDI adhesive.

The MDI adhesive with a formaldehyde-containing resin accelerator may be used for a variety of wood composites, and is quite advantageous for use with OSB. Furthermore, the relatively small addition of the formaldehyde-containing resin accelerator to the MDI adhesive of the novel invention reduces the possibilities of line plugging due to excessive pre-reaction while still accelerating the MDI reaction within the adhesive. As such, the adhesive composition may be applied in any conventional method to the lignocellulosic material in forming the wood-based composite, especially OSB.

Advantageously, in manufacturing a wood-based composite using the novel adhesive, an MDI adhesive is provided with the formaldehyde-containing resin accelerator being added in an amount of from about 1% to about 40% and more preferably of from about 1% to about 15%. The adhesive with accelerator of the present invention is applied to the lignocellulosic material and subsequently the mixture is exposed to an elevated temperature and pressure to form the wood composite material.

An object of the invention, therefore, is a method of manufacturing a wood composite which functions at a lower press temperature or reduced press time in the manufacturing process.

Yet another object of the invention is a method of manufacturing a wood-based composite where the adhesive utilized in the manufacturing provides a faster cure rate than conventional wood adhesives.

Still another object of the invention is a wood composite including a cured adhesive that is a reaction product of a MDI adhesive with a formaldehyde-containing resin accelerator.

Yet another object of the invention is an adhesive for use in creating wood-based composites in which the manufacturing process produces lower VOC and HAP emissions.

Still another object of the invention is an adhesive for use in manufacturing OSB with reduced air pollution abatement costs.

These aspects and others that will become apparent to the artisan upon review of the following description can be accomplished by providing a lignocellulosic material and an MDI adhesive with a formaldehyde-containing resin accelerator in the amount of from about 1% to about 40% by weight of the adhesive, and subsequently applying the MDI adhesive with accelerator to the lignocellulosic materials. The inventive adhesive advantageously cures faster in creating wood-based composite materials when compared to prior art processes. As such, lower press temperatures are required in the manufacturing of a wood-based composite utilizing the adhesive of the present invention. Furthermore, the lower temperature requirements of the novel adhesive result in the emission of less VOCs and HAPs than prior art processes.

It is understood that both the foregoing general description and the following detailed description, when taken in conjunction with the accompanying drawing, provide embodiments of the invention and are intended to provide an overview of framework of understanding to nature and character of the invention as it is claimed.

### BRIEF DESCRIPTION OF THE DRAWINGS

FIG. 1 is a DSC graph of the cure temperature comparison between the present invention and conventional processes.

FIG. 2 is a graph of the internal bond strength achieved with practice of the present invention, as compared to conventional processes.

### DETAILED DESCRIPTION OF THE PREFERRED EMBODIMENTS

Wood composites in accordance with the present invention are prepared from lignocellulosic materials and the novel adhesive. The term “wood composite” is used herein to describe composites known as particle board, chip board, wafer board, fiber board, and oriented strand board (OSB) wherein the board substrate is prepared by application of the adhesive system to the lignocellulosic material including particles, chips, fibers, specifically wood particles, wood chips, and lignocellulosic fibers and subsequently formed into the desired board through application of heat and pressure. Further detail concerning lignocellulosic materials which may be utilized in forming wood composites is described in U.S. Pat. No. 6,297,313 issued to Hsu which is hereby incorporated by reference in its entirety. Additionally, the method and product of the present invention and its advantages over the prior art, can be realized with the respect to a wide variety of lignocellulosic substrate materials, and as such, may be used with a wide variety of particle type and form.

Generally, the process of creating a wood-based composite involves the consolidation or joining together of lignocellulosic materials using pressure, heat, and adhesive. The adhesive as described herein is useful for a wide variety of wood composites and is particularly useful in forming OSB products.

In forming a wood-based composite with the adhesive in accordance with the present invention, a substrate of lignocellulosic material is selected based upon the desired type of wood composite. Typically, such substrates include wood particles derived from wood and wood residues such as wood chips, wood fibers, shavings, veneers, wood wool, cork, bark, sawdust, as well as other wood-based materials. Particles of other lignocellulosic materials including shredded paper, pulp, vegetable fibers such as corn stalks, straw, bagesse, and combinations thereof which also be utilized. Additives may also be combined to form wood products with the adhesive system to provide wood-based composites with a variety of characteristics. These additives may include various rubber and polymer elements as well as additives to impart fire retardancy, conductivity, or any other desirable characteristic for the composite.

Wood-based composites of the present invention may be produced by bonding together lignocellulosic materials by using heat, pressure, and the adhesive of the present invention. The invention particularly relates to a use of an adhesive system wherein the lignocellulosic material is contacted with a MDI adhesive with formaldehyde-containing resin accelerator and subsequently formed into wood-based composites by the application of heat and pressure to cure the adhesive and form the wood-based composite. Wood-based composites of the present invention using the MDI adhesive with accelerator may include wafer board, particle board, plywood, oriented strand board, medium density fiber board, and the like.

The adhesive of the present invention comprises a MDI polymer which is also known as an isocyanate with the accelerator comprising a formaldehyde containing resin. The MDI adhesive with formaldehyde-containing resin accelerator is combined and subsequently added to lignocellulosic material. While blending the MDI adhesive and resin accelerator prior to application is preferred, in processes where a higher percentage of formaldehyde-containing resin accelerator is necessitated, the separate application of the MDI adhesive and the formaldehyde-containing resin accelerator may be desirable.

The MDI adhesive is generally known as an isocyanate polymer. MDI is more specifically described as an aromatic diisocyanate with three different isomers. For use as the adhesive of the present invention the MDI preferably includes at least about 2 active isocyanate groups per molecule. The functionality of the MDI is of at least about two and preferably ranges from about 2.3 to about 3.5.

Furthermore, in other embodiments of the invention, additional isocyanate polymers can be utilized including those that are typically employed in adhesive compositions, including typical aromatic, aliphatic and cycloaliphatic isocyanate polymers. Representative aromatic isocyanate polymers are discussed in U.S. Pat. No. 4,209,433, the disclosure of which is hereby incorporated by reference in its entirety. Generally the adhesive may include 2,4-tolylene diisocyanate, 2,6-tolylene diisocyanate, 4,4′-methylene bis(phenyl isocyanate), 1,3-phenylene diisocyanate, triphenylmethane triisocyanate, 2,4,4′-triisocyanatodiphenyl ether, 2,4-bis(4-isocyanatobenzyl)phenylisocyanate and related polyaryl polyiscocyanates, 1,5-naphthalene diisocyanate and mixtures thereof. Representative aliphatic isocyanate polymers include hexamethylene diisocyanate, xylylene diisocyanate, 1,12-dodecane diisocyanate and lysine ethyl ester diisocyanate. Representative cycloaliphatic isocyanate polymers include 4,4′-methylenebis (cyclohexyl isocyanate), 1,4-cyclohexylene diisocyanate, 1-methyl-2,4-cyclohexylene diisocyanate and 2,4-bis(4-isocyanatocyclohexylmethyl)cyclohexyl isocyanate.

The formaldehyde-containing resin accelerator of the present invention is often described as a type of thermosetting polymer and, in the preferred embodiment, is urea-formaldehyde, melamine-formaldehyde, melamine-urea-formaldehyde, and melamine-urea-phenol-formaldehyde, and combinations thereof, among others. Generally, the formaldehyde-containing resin accelerators are created through a condensation reaction of formaldehyde, with a compound containing an amino or phenolic group. Preferably, formaldehyde is utilized in forming the resin though other aldehydes may also be used including acetaldehyde, propionaldehyde, furfuraldehyde, benzaldehyde, and as well as combinations thereof. The formaldehyde-containing resin accelerator most often has a molar ratio of formaldehyde to an amino in a range of from about 0.5:1 to about 1.5:1 for use as accelerator of the MDI adhesive.

The formaldehyde-containing resin accelerator is generally added to the MDI adhesive in a substitution where the formaldehyde-containing resin accelerator replaces a portion of the MDI adhesive. Substitution rates up to about 40% are possible with a preferred substitution range of from about 1% to about 25%, most preferably from about 1% to about 15%. As previously mentioned, the use of formaldehyde-containing resin accelerators accelerates the cure speed of the mixture and may provide for low-temperature pressing of OSB boards at, for example, temperatures of about 350° F. More specifically, the practice of the present invention can result in the temperature which can be 30° F., 40° F. or even 50° F. or more less than the temperature for the same method without the formaldehyde-containing resin accelerator.

Advantageously, the use of the formaldehyde-containing resin accelerator, significantly reduces VOC and HAP emissions as the press temperature is reduced significantly, where prior art processes often use press temperatures of greater than 390° F. which can result in greater VOC and HAP emissions. This reduction in VOC and HAP emissions may desirably reduce or preclude the necessity of the installation and/or operation of pollution abatement controls such as Regenerative Thermal Oxidizers as the low temperature pressing with the MDI adhesive and formaldehyde-containing resin accelerator produces significantly less emissions.

The formaldehyde-containing resin accelerator is generally understood to both react with the MDI adhesive and accelerate the MDI reaction itself. To further illustrate the principles and operation of the present invention, the following examples are provided. However, these examples should not be taken as limiting in any regard.

### Example 1

Two facing veneers are painted with resin to simulate bonding characteristics at the core of a portion of OSB. A sandwich is formed with two unresinated veneers on the outer surfaces and the two facing veneers in between with the four veneers having a thickness of about 0.60″ that is pressed to stops at 0.40″. Table 1 illustrates that substitution over a wide range of MUF resin yields a well-bonded board when pressed under mild conditions, 350° F. for a press time of 115 seconds, whereas MDI alone did not bond at all alone. As is further illustrated, a 1% addition of a formaldehyde-containing resin accelerator provided adequate bonding.

TABLE 1
In-Press Bonding Performance at 350° F. and 115
Minute Press time

| Resin | In-press Bonding |
|---|---|
| MDI | None |
| MDI with 1% SA-102 catalyst | Adequate |
| MDI with 2% triethylamine | Adequate |
| MDI with 15% MUF liquid | Adequate |
| MDI with 5% MUF liquid | Adequate |
| MDI with 5% MUF liquid | Adequate |
| MDI with 5% water | Slight |

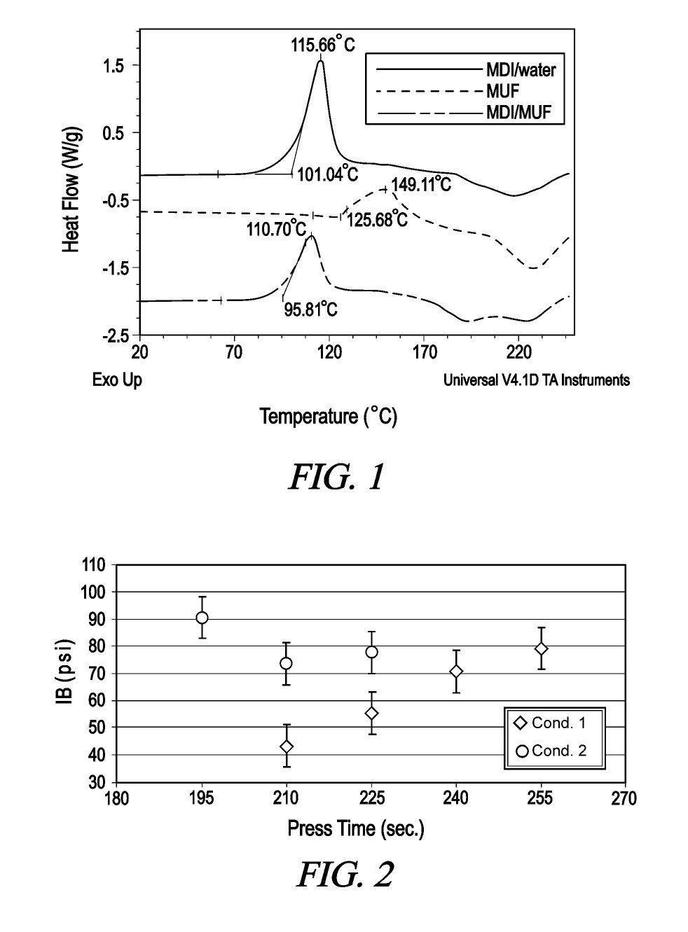

In addition, FIG. 1 attached hereto illustrates how the practice of the present invention results in lower energy requirements for production of a wood composite as described herein. More specifically, FIG. 1 shows that the onset of bonding at 95.81° C., with a maximum of 110.70° C., whereas other processes require much higher peak temperatures and are not initiated until a higher temperature is reached.

For each MDI adhesive with a formaldehyde-containing resin accelerator, the accelerator contains water which may further accelerate curing of the MDI adhesive. However, water alone does not provide the benefit of the accelerator.

### Example 2

Three-layer strand boards are made as follows. The surface layers constitute 60% of the total board weight, while the core layer constitutes 40% of the weight. Southern Yellow Pine strands are obtained from an OSB mill. The strands are screened and dried to 9-11% moisture content, and then blended with a pMDI resin (with and without an accelerator) and a wax emulsion. Wax is added at 0.7% rate, based on oven-dried wood weight. The resin and accelerator application rates (based on oven-dried wood weight) are shown in Table 2.

TABLE 2

| Condition # | Face Resin | Core Resin | Core Accelerator |
|---|---|---|---|
| 1 | 2% pMDI | 2% pMDI | None |
| 2 | 2% pMDI | 2% pMDI | 0.3% MUF |

The boards are pressed at 330° F. for various press times to a target density of 40 pcf and a target thickness of 23/32″. The boards are then tested for internal bond (IB) strength. The results are shown in FIG. 2. The results demonstrate that the addition of the accelerator increased the cure speed of the resin system.

The above examples illustrate the use of formaldehyde-based resins in accelerating the curing of MDI which may also be understood to permit the use of drastically lower press temperatures during manufacturing.

The adhesive of the present invention may be applied to the lignocellulosic materials through standard application techniques. Preferably, formaldehyde-containing resins are substituted for up to about 40%, more preferably from about 1% to about 25%, and most preferably about 1% to about 15% of the MDI adhesive for the production of a wood composite. More specifically, the fabrication of a wood-based composite of the present invention involves the application of the MDI adhesive with the formaldehyde-containing resin accelerator to the lignocellulosic particles with the subsequent application of heat and pressure to form the wood composite in its desired configuration. Furthermore, the adhesive and accelerator combination may be applied through a variety of conventional means including spray coating so that the adhesive is substantially evenly distributed among the lignocellulosic material.

Accordingly, by the practice of the present invention, an adhesive system for creating wood-based composites having heretofore unrecognized characteristics is disclosed. This adhesive system comprising a MDI adhesive with a formaldehyde-containing resin accelerator provides for a significant decrease in the required energy for the curing of the adhesive, and thus advantageously allows for a decrease in the temperature or time necessary to form wood composites making such an adhesive uniquely effective in the manufacturing of wood-based composites.

The disclosure of all cited patents and publications referred to in this application are incorporated herein by reference.

The above description is intended to enable the person skilled in the art to practice the invention. It is not intended to detail all the possible variations and modification that are apparent to the skilled worker upon reading the description. It is intended, however, that all such modifications and variations be included within the scope of the invention that is defined by the following claims. The claims are intended to cover the indicated elements and steps that any arrangement or sequence that is effective to meet the objectives intended for the invention unless the context specifically indicate the contrary.

What is claimed is:

1. A method of manufacturing a wood composite comprising the steps of:
a) providing an isocyanate adhesive comprising at least one isocyanate polymer;
b) providing a formaldehyde-containing resin accelerator;
c) applying the isocyanate adhesive and the formaldehyde-containing resin to a lignocellulosic material to form an adhesive lignocellulosic mixture;
d) applying an elevated temperature to the adhesive lignocellulosic mixture to form the wood composite wherein the temperature is less than the temperature for the same method without the formaldehyde-containing resin accelerator.

2. The method of claim 1 wherein the isocyanate polymer comprises methylene diphenyl diisocyanate.

3. The method of claim 1 wherein the isocyanate polymer comprises a polymer selected from the group consisting of 2,4-tolylene diisocyanate, 2,6-tolylene diisocyanate, 4,4′-methylene bis(phenyl isocyanate), 1,3-phenylene diisocyanate, triphenylmethane triisocyanate, 2,4,4′-triisocyanatodiphenyl ether, 2,4-bis(4-isocyanatobenzyl)phenylisocyanate and related polyaryl polyiscocyanates, 1,5-naphthalene diisocyanate, hexamethylene diisocyanate, xylylene diisocyanate, 1,12-dodecane diisocyanate, lysine ethyl ester diisocyanate, 4,4′-methylenebis, 1,4-cyclohexylene diisocyanate, 1-methyl-2,4-cyclohexylene diisocyanate, 2,4-bis(4-isocyanatocyclohexylmethyl)cyclohexyl isocyanate and combinations thereof.

4. The method of claim 1 wherein the formaldehyde-containing resin accelerator comprises an amino formaldehyde.

5. The method of claim 4 wherein the amino resin carrier comprises urea-formaldehyde, melamine-formaldehyde, melamine-urea-formaldehyde, amino-containing aldehydes and combinations thereof.

6. The method of claim 1 wherein the formaldehyde-containing resin accelerator comprises a resin selected from the group consisting of urea-formaldehyde, melamine-formaldehyde, melamine-urea-formaldehyde, and melamine-urea-phenol-formaldehyde, and combinations thereof.

7. The method of claim 1 wherein the formaldehyde-containing resin accelerator comprises less than about 40% by weight of the accelerated adhesive mixture.

8. The method of claim 7 wherein the formaldehyde-containing resin accelerator comprises of from about 1% to about 15% by weight of the accelerated adhesive mixture.

9. The method of claim 7 wherein the formaldehyde-containing resin accelerator comprises of from about 1% to about 5% by weight of the accelerated adhesive mixture.

10. The method of claim 1 wherein the temperature in step (d) is 30° F. less than the temperature for the same method without the formaldehyde-containing resin accelerator.

11. The method of claim 10 wherein the temperature in step (d) is 50° F. less than the temperature for the same method without the formaldehyde-containing resin accelerator.

12. The method of claim 1 wherein the forming of the wood composite of step d) further comprises curing the adhesive with formaldehyde-containing resin accelerator faster than a similar adhesive not having the formaldehyde-containing resin accelerator.

13. The method of claim 1 wherein the wood composite comprises a composite selected from the group consisting of wafer board, particle board, plywood, oriented strand board, medium density fiber board, and combinations thereof.

14. The method of claim 1 wherein the wood composite comprises oriented strand board.

15. A method of manufacturing a wood composite comprising the steps of:
a) creating an adhesive composition comprising a MDI adhesive of at least 60% by weight of the adhesive composition and a formaldehyde-containing resin accelerator of at most 40% by weight of the adhesive composition;
b) combining the adhesive composition with lignocellulosic material to form an adhesive lignocellulosic mixture;
c) applying an elevated temperature and an elevated pressure to the adhesive lignocellulosic mixture to form the wood composite.

16. The method of claim 15 wherein in step a) the MDI adhesive comprises at least 85% by weight and the formaldehyde-containing resin accelerate comprises at most 15% by weight of the adhesive composition.

17. A wood composite comprising a lignocellulosic material and a cured adhesive, wherein the cured adhesive comprises a linked polymer that is a reaction product of a MDI adhesive accelerated by a formaldehyde-containing resin accelerator.

18. The wood composite of claim 17 wherein the wood composite is selected from the group consisting of wafer board, particle board, plywood, oriented strand board, medium density fiber board, and combinations thereof.

19. An adhesive for a wood composite comprising:
a MDI adhesive comprising at least one isocyanate polymer; and
a formaldehyde-containing resin accelerator wherein the formaldehyde-containing resin accelerator provides for faster curing of the MDI adhesive than for the reaction without the formaldehyde-containing resin accelerator.

20. The adhesive of claim 19 wherein the formaldehyde-containing resin accelerator comprises less than about 40% by weight of the adhesive.
